(19) United States
(12) Patent Application Publication
(10) Pub. No.: US 2021/0019759 A1
(43) Pub. Date: Jan. 21, 2021

(54) METHOD FOR REPORTING INCIDENTS INVOLVING VEHICLES

(71) Applicants: Giuseppe Pede, Toronto (CA); Gennaro Iacobucci, Toronto (CA)

(72) Inventors: Giuseppe Pede, Toronto (CA); Gennaro Iacobucci, Toronto (CA)

(21) Appl. No.: 16/905,238

(22) Filed: Jun. 18, 2020

(30) Foreign Application Priority Data
Jul. 19, 2019 (CA) CA 3050227

(51) Int. Cl. G06Q 30/00

(52) U.S. Cl. CPC G06Q 30/018

(57) ABSTRACT

The present invention relates generally to a method for reporting moving vehicle incidents, and more specifically to an online method for reporting incidents, building a database of incidents, and accessing relevant services required after such incidents. The computer-implemented method for reporting incidents involving vehicles and creating a database of incidents involving vehicles comprises the means for reporting incidents involving vehicles and accessing a database of incidents involving vehicles. A reporter of an incident involving a vehicle inputs data related to the incident involving a vehicle and a report is created which may be sent to police, transportation authorities and insurance companies. These incident reports cumulatively provide a searchable database of reports which can be used to determine information on a specific vehicle and general trends in vehicle incidents.

### FIELD OF THE INVENTION

The present invention relates generally to a method for reporting incidents involving vehicles, and more specifically to a portal for reporting incidents involving vehicles, creating a database of incidents, and accessing relevant services and resources.

### BACKGROUND OF THE INVENTION

When there is a collision between two motor vehicles, the owners may exchange contact information and deal with the repair and costs with or without getting an insurance company or alerting the police. In more serious incidents the vehicle owners or bystanders call the police and the police and/or a tow truck driver appears.

Tow truck drivers may have financial incentives to bring a damaged vehicle to a specific collision reporting center and specific auto repair shop. If the jurisdiction requires the tow truck driver to bring the damaged vehicle first to a collision reporting center, a police officer inspects and gives an estimate of the damage and places a sticker on the damaged parts(s). This typically involves a long wait for the owner of the damaged vehicle.

The owner of the damaged vehicle may be influenced by their insurance company as to which auto repair or body shop to use. The insurance company's bias is to fix the vehicle at least cost which may mean that salvaged parts, used parts, or lower quality new parts (“inferior parts”) are used in the repair etc. unbeknownst to the vehicle owner or a subsequent purchaser. However, it is in the best interest of the present and future vehicle owners to be aware about the nature of the repair of the vehicle, for example, since inferior parts may not last and may void vehicle warranties.

There are methods of detecting an accident when it occurs and reporting to a network which then prompts the user to take a photo of any other vehicle in the accident. U.S. patent Ser. Nos. 15/156,420 and 15/823,425 (by inventors Joodaki and Shaoy, assigned to International Business Machines Corporation) for Vehicle Accident Reporting System identifies a sudden event when a measured acceleration of the vehicle exceeds a predefined maximum acceleration or deceleration indicative of an accident. A notification that a sudden event has occurred is transmitted to an accident management hub, the notification including a vehicle identification, current video data, and GPS coordinates. An insurance provider is identified by retrieving insurance provider information associated with the vehicle. A prompt is transmitted to a mobile device requesting a photograph of the license plate of other vehicles involved in the accident and video of the accident scene. The requested license plate image and video of the accident scene are received from the mobile device, and an accident notification is transmitted to the insurance provider's computer system, the accident notification including the vehicle identification, current video data and GPS coordinates.

However, this only provides information to the insurance company of an accident and the two parties involved. This does not assist the owner of the vehicle in dealing with the consequences of an accident or create a permanent record of the history of a particular motor vehicle. Accordingly, it is desirable to have a centralized online method for owners of moving vehicles to report accidents and access relevant services.

### SUMMARY OF THE INVENTION

In an embodiment of the present invention there is a computer-implemented method for reporting incidents involving vehicles and creating a database of incidents involving vehicles comprising:
a host portal for reporting incidents involving vehicles and accessing a database of incidents involving vehicles;
a server for executing a plurality of software applications including:
   a registration module for registering a reporter of an incident involving a vehicle;
   an input module for entering data related to the incident involving a vehicle;
   a processing module for creating a vehicle incident report from the data;
   a data storage module for storing and displaying data regarding one or more incident involving a vehicle;
   a reporting module to enable the reporter to send the report to one or more entities;
   a search module for searching a database of one or more incident involving a vehicle; and
a searchable database of the data and at least one report of an incident involving a vehicle.

The portal may additionally comprise one or more sub-portals, such as, Report Vehicle Incident; Report Weather Incident; Incident Database; Access Services & Information; Post-Incident Reporting.

The registration module may allow third party entities access to the database and certain access may also allow inputting e.g. an automobile manufacturer may enter a notification on a specific vehicle that a warranty is void.

The Access Related Services & Information sub-portal has links to relevant information, such as, license collision repair centres, licensed towing companies, registered automotive retail dealers, insurance companies and brokers, vehicle rental companies, automotive warranties, motor vehicle repair laws and regulations, motor vehicle repair guidelines. Further information may be made available, such as, nearby restaurants, hospitals, clinics etc.

The entities receiving a report, or a portion of a report, may include police; vehicle licensing authority; vehicle incident reporting authority; insurance company; insurance broker; collision centre; towing company; automotive manufacturer.

The reporting module enables the reporter to send the report to a transportation authority and the transportation authority generates a record of identification. The transportation authority can additionally enter data through the input module regarding the vehicle. The data that the transportation authority enters may include categories, such as, that vehicle is a write off, vehicle is stolen, vehicle is recovered from stolen, a cost of the repair, a description of the repair, a description of the incident.

In an embodiment of the invention, the method also enables data analysis to determine information about incident trends, such as, prevalence of types of incidents, location of most incidents, accident trends. As such, the plurality of software applications may additionally comprise a filtering module to enable data analysis on the data.

The method of the present invention may provide information on the use by reporters of the various service providers and services offered through the portal. The plurality of software applications may additionally include a tracking module, for tracking when a reporter links to one or more of the service providers. The plurality of software applications may additionally include a payment module, for the service providers to pay the host when a reporter links to that service provider.

The input module may additionally allow entry of data relating to repair of the vehicle by a service provider and the plurality of software applications may additionally comprise an audit module to enable auditing of the service provider.

The processing module may additionally detect discrepancies and insurance issues in the data and generate a report including an alert notification to the transportation authority.

Other authorities may likewise be permitted to input additional data and/or receive alerts. For example, the processing module may additionally detect data related to warranty coverage and generate a report notifying the vehicle manufacturer, and further, the vehicle manufacturer may enter data relating to the status of a vehicle's warranty.

### BRIEF DESCRIPTION OF THE FIGURES

These and other aspects of the present invention will be apparent from the brief description of the drawings and the following detailed description in which:

FIG. 1 is schematic of the available selections through a host portal in an embodiment of a method for reporting incidents involving vehicles.

FIG. 2 is a schematic of the available service provider and information selections through a host portal in an embodiment of a method for reporting incidents involving vehicles.

### DETAILED DESCRIPTION OF THE INVENTION

In an embodiment of the present invention, there is a method for owners of moving vehicles to report incidents and access relevant services through a portal. The use of this method creates a permanent online central registry for motorized vehicle incidents, particularly accidents involving other vehicles. With the inclusion of post-incident reporting the registry documents the history of incidents involving a particular vehicle as well as the costs and repairs done by service providers.

One skilled in the art will understand that there are various ways in which to set up a computer-implemented method of the present invention, and that the method is accessible by smart device or computer.

In an embodiment of the present invention there is a computer-implemented method for reporting incidents involving vehicles and creating a database of incidents involving vehicles comprising a host portal for reporting incidents involving vehicles and accessing a database of incidents involving vehicles, a server, and a searchable database containing the data and reports. In an embodiment of the invention the server executes various functions through a plurality of software applications such as a registration module for registering a reporter of an incident involving a vehicle or for registering an entity seeking access to the database; an input module for entering data related to the incident involving a vehicle; a processing module for creating a vehicle incident report from the data; a data storage module for storing and displaying data regarding one or more incident involving a vehicle; a reporting module to enable the reporter to send the report to one or more entities; and a search module for searching a database of one or more incident involving a vehicle.

In order for the reporter of the incident involving a vehicle to answer the most relevant questions or access the information desired, the initial interface with a user of the method of the present invention may be subdivided or presented in sub-portals, for example, Report Vehicle Incident; Report Weather Incident; Incident Database; Access Services & Information; Post-Incident Reporting.

The category of Access Related Services & Information could be subdivided into services and information. The services and information may include links to: license collision repair centres, licensed towing companies, registered automotive retail dealers, insurance companies and brokers, vehicle rental companies, automotive warranties, motor vehicle repair laws and regulations, motor vehicle repair guidelines.

In the method of the present invention, the report may be sent to various entities: police; vehicle licensing authority; vehicle incident reporting authority; insurance company; insurance broker; collision centre; towing company; automotive company.

In an embodiment of the invention, the reporting module enables the reporter to send the report to a transportation authority and the transportation authority generates a record of identification. The transportation authority can additionally enter data through the input module regarding the vehicle, such as: vehicle is a write off, vehicle is stolen, vehicle is recovered from stolen, a cost of the repair, a description of the repair, a description of the incident.

The plurality of software applications additionally comprises a filtering module to enable data analysis on the data. The data analyse may determine such information as: prevalence of types of incidents, location of most incidents, accident trends.

In an embodiment of the invention there are links to service providers, and the plurality of software applications additionally includes a tracking module for tracking when a reporter links to one or more of the service providers, and a payment module for the service providers to pay the host when a reporter links to that service provider.

In a further embodiment of the invention, the input module additionally allows entry of data relating to repair of the vehicle by a service provider and the plurality of software applications additionally comprises an audit module to enable auditing of the service provider.

In an embodiment of the present invention, this central registry is maintained at a provincial or state level. In a further embodiment of the invention the provincial or state registries are integrated to form a national or international database.

The method of the present invention is a one-step process for reporting a vehicle accident/incident to an insurance company, insurance broker, collision repair facility, and a transportation authority. As will be understood by those skilled in the art, other relevant parties can be added to the one-step reporting process and distribution of reports, for example, automotive rental companies.

This one-step reporting method eliminates the need for motor vehicle accident victims to go to reporting centers. Vehicles may be brought directly to a collision repair facility without their owners.

The portal may also contain the necessary collision and incident information for a reporter of an incident involving a vehicle, such as, lists of licensed collision repair facilities, current repair guidelines, manufacturers repair, parts and warranty guidelines, laws governing vehicle repairs under the Motor Vehicle Repair Act.

The portal provides a database for a transportation authority to access to audit and review the performance of service providers, such as, automotive rental companies, collision repair facilities and tow companies.

The method allows a transportation authority to detect any insurance coverage deviation, for example, lapsed insurance, no insurance and insurance differing from what current records indicate. The server may automatically update all new and acceptable data to the server, or notify the driver of an insurance coverage violation. This method may be used to immediately remove unauthorized vehicles from the road and place the driver on probation.

The information in the incident report will allow the transportation authority to immediately categorize and label the vehicle if necessary, for example, Collision Repair record, Vehicle Write-off, Stolen or Stolen Recovery, Weather Incident Claim etc. and provide details of the repair and dollar amount.

Through the data analyses the transportation authority can track vehicle thefts by makes of vehicles or specific geographic areas targeted. Discrepancies in data entered are detected through computer algorithms which test the veracity of insurance premiums based on postal codes. The data can be used to forecast accident trends by time, location and region, or by gender, age and ethnic background.

The method of the present invention provides transparency and detection of black-market activity in the tow industry, cash kickbacks to tow drivers and faulty workmanship, and as such these activities are not sustainable.

In an embodiment of the present invention, the method requires that all vehicles in a province/state or country must be registered in the database at the time of purchase or obtaining registration plates or papers for the vehicle, and all owners are required to enter any accident/incident reports and all service providers who interact with a vehicle are required to enter the data relating to same.

The method may be used for any moving vehicles, for example scooters and drones, provided that there is a license or other means of identifying the vehicle.

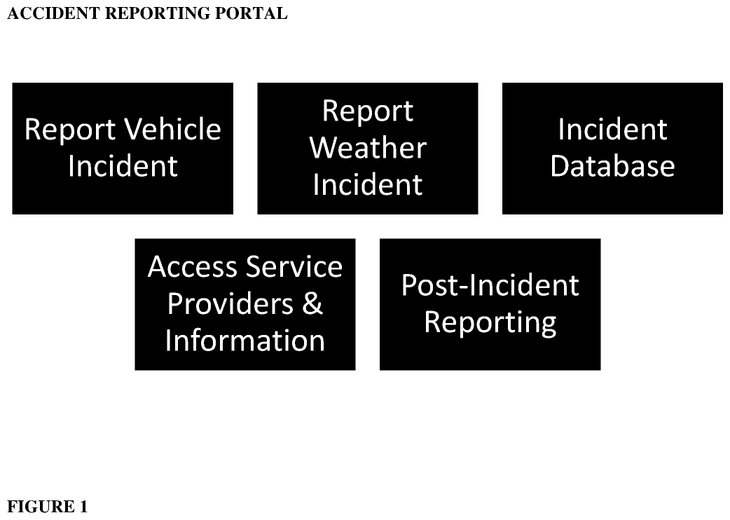

The portal of the present invention may be configured in various ways, and one embodiment is shown in FIG. 1 in which a motor vehicle owner after an accident or incident selects a category or sub-portal of Report Vehicle Accident/Incident, Weather Incident, Incident Database, Access Service Providers & Motor Vehicle Information and Reporting Post-Incident.

In an embodiment of the invention, the database is controlled by a transportation authority. In an alternate or coexisting embodiment, the database generates revenue through providing lists of service providers who benefit from being in the portal, for example, with payment for linking to service providers and/or to using their services. The database can be configured to list all local service providers and generate revenue through higher rankings of service providers who pay ranking fees and/or including advertisements of service providers who pay fees to place ads on the portal.

Service providers on the portal may include Licensed Collision Repair Facilities, licensed Towing Companies, Registered Automotive Retail Dealers, Insurance Companies and Brokers and Vehicle Rental Companies.

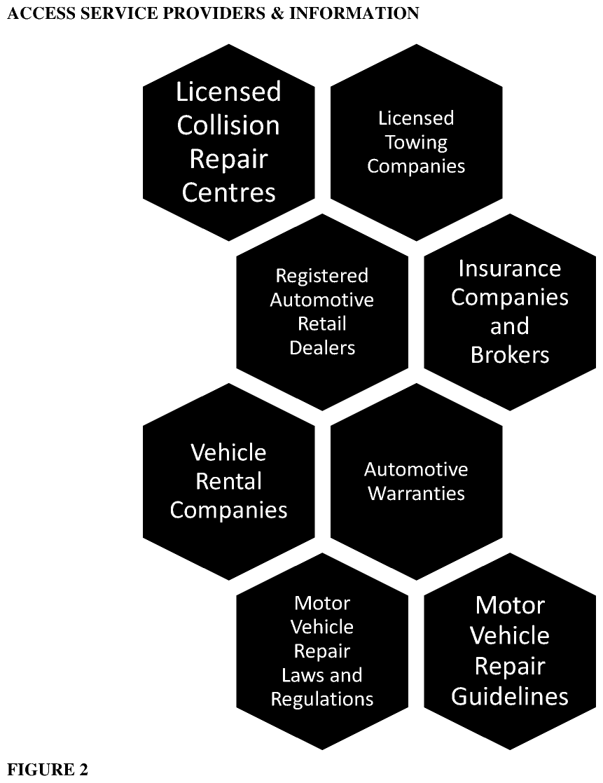

FIG. 2 is an embodiment of the type of information that may be provided through the portal namely the above service providers as well as information that is helpful after an accident, such as, automotive warranties information, motor vehicle repair guidelines as well as laws and regulations.

Example 1 provides lists of possible questions to obtain the type of information to create a report of a weather incident involving a motor vehicle. Such information may include the identification of the vehicle, location of the accident, date, the type of event or a selection of pre-populated events such as tree branch, lightening, falling ice, hail etc. The type of damage may be provided and the parts of the vehicle damaged. The insurance company and broker may be selected from a pre-populated list and/or specific information inputted, as well as the policy number and expiry date.

Inputting such information can also alert transportation authorities if it reveals that insurance has expired etc.

EXAMPLE 1—is a list of questions for which the answers are data to enter to create a report in an embodiment of a method for reporting weather related incidents involving vehicles.

Example 2 provides lists of possible questions to obtain the type of information to create a report of a when there is a vehicle accident/incident. And the reporter can select subdivided categories such as a stolen vehicle or accidents with one of the following: other motor vehicles, motorcycles, autonomous vehicles, drone, other flying vehicle; bicycles/pedestrians; or property (e.g. a house porch or lamp post).

Example 2 lists questions to obtain information relating to motor vehicle accidents with other motor vehicles, motorcycles, autonomous vehicles, drones, or other flying vehicles.

EXAMPLE 2—is a list of questions for which the answers are data to enter to create a report in an embodiment of a method for reporting incidents involving vehicles with other vehicles.

Doctor phone number

Example 3 provides lists of possible questions to obtain information relating to a motor vehicle accident with a bicycle or pedestrian.

EXAMPLE 3—is a list of questions for which the answers are data to enter to create a report in an embodiment of a method for reporting incidents involving vehicles with bicycles or pedestrians.

Name

Plate Number

Phone number

Example 4 provides lists of possible questions to obtain information relating to a motor vehicle accident with property.

EXAMPLE 4—is a list of questions for which the answers are data to enter to create a report in an embodiment of a method for reporting incidents involving vehicles with property.

Example 5 provides lists of possible questions to obtain information relating to when a motor vehicle is stolen.

EXAMPLE 5—is a list of questions for which the answers are data to enter to create a report in an embodiment of a method for reporting incidents involving vehicles which are stolen.

After any of the above incidents, weather or other events, the method of the invention may further provide the option or requirement of reporting information about the repair of the motor vehicle as set out in Example 6. Example 6 provides lists of possible questions to obtain information after the repair of a vehicle involved in any accident or incident. In this way there is a record of whether the owner witnessed what happened to the parts removed from the vehicle and what parts were installed. The owner may also report the satisfaction level and whether a written warranty was provided. This type of information may be accessible to a prospective purchaser of the same motor vehicle.

EXAMPLE 6—is a list of questions for which the answers are data to enter to create a post-incident report in an embodiment of a method for reporting incidents involving vehicles.

The report may further be sent to vehicle manufacturers to upload to their own databases. Vehicle manufacturers can then access the database information on the particular vehicle to include a note that an incident or the repair of an incident resulted in a void warranty.

It will be understood that the method for reporting incidents is implementable in various ways, including via an application programming interface or platform through which arms-length entities control their own contributions, for example, a transportation authority could manage the database and control access to searching it, and an association of collision centers would manage the collision centers contact information and reporting obligations, and a towing truck association would manage their members and assign towing jobs based on proximity to incidents etc.

While embodiments of the invention have been described in the detailed description, the scope of the claims should not be limited by the preferred embodiments set forth in the examples but should be given the broadest interpretation consistent with the description as a whole.

What is claimed is:

1. A computer-implemented method for reporting incidents involving vehicles and creating a database of incidents involving vehicles comprising:
a host portal for reporting incidents involving vehicles and accessing a database of incidents involving vehicles;
a server for executing a plurality of software applications including:
a registration module for registering a reporter of an incident involving a vehicle;
an input module for entering data related to the incident involving a vehicle;
a processing module for creating a vehicle incident report from the data;
a data storage module for storing and displaying data regarding one or more incident involving a vehicle;
a reporting module to enable the reporter to send the report to one or more entities;
a search module for searching a database of one or more incident involving a vehicle; and
a searchable database of the data and at least one report of an incident involving a vehicle.

2. The method of claim 1, wherein the portal additionally comprises one or more sub-portals from the group consisting of: Report Vehicle Incident; Report Weather Incident; Incident Database; Access Services & Information; Post-Incident Reporting.

3. The method of claim 1, wherein the registration module is additionally for registering an entity seeking access to the database.

4. The method of claim 1, wherein the portal additionally comprises a sub-portal providing Access Related Services & Information which links to one or more of the following: license collision repair centres, licensed towing companies, registered automotive retail dealers, insurance companies and brokers, vehicle rental companies, automotive warranties, motor vehicle repair laws and regulations, motor vehicle repair guidelines.

5. The method of claim 1, wherein the one or more entities is selected from a group comprising: police; vehicle licensing authority; vehicle incident reporting authority; insurance company; insurance broker; collision centre; towing company; automotive manufacturer.

6. The method of claim 1, wherein the reporting module enables the reporter to send the report to a transportation authority and the transportation authority generates a record of identification.

7. The method of claim 6, wherein the transportation authority can additionally enter data through the input module regarding the vehicle.

8. The method of claim 7, wherein the data that the transportation authority enters is selected from the following information: vehicle is a write off, vehicle is stolen, vehicle is recovered from stolen, a cost of the repair, a description of the repair, a description of the incident.

9. The method of claim 5, wherein the portal additionally comprises one or more sub-portals from the group consisting of: Report Vehicle Incident; Report Weather Incident; Incident Database; Access Services & Information; Post-Incident Reporting.

10. The method of claim 1, wherein the plurality of software applications additionally comprises a filtering module to enable data analysis on the data.

11. The method of claim 9, wherein the data analysis provides one or more of the following information: prevalence of types of incidents, location of most incidents, accident trends.

12. The method of claim 1, wherein the portal provides links to service providers, and the plurality of software applications additionally includes a tracking module, for tracking when a reporter links to one or more of the service providers, and a payment module, for the service providers to pay the host when a reporter links to that service provider.

13. The method of claim 1, wherein the input module additionally allows entry of data relating to repair of the vehicle by a service provider and the plurality of software applications additionally comprises an audit module to enable auditing of the service provider.

14. The method of claim 6, wherein the processing module may additionally detect discrepancies and insurance issues in the data and generate a report including an alert notification to the transportation authority.

15. The method of claim 6, wherein the processing module may additionally detect data related to warranty coverage and generate a report notifying the vehicle manufacturer.

16. The method of claim 15, wherein the input module additionally allows entry of data relating to warranty by a vehicle manufacturer.
